(19) United States
(12) Patent Application Publication
(10) Pub. No.: US 2004/0136600 A1
(43) Pub. Date: Jul. 15, 2004

(54) Visually lossless still image compression for RGB, YUV, YIQ, YCrCb, K1K2K3 formats

(76) Inventor: Evangelos A. Yfantis, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/746,513

(22) Filed: Dec. 24, 2003

Related U.S. Application Data
(63) Continuation of application No. 09/645,211, filed on Aug. 24, 2000, now abandoned.
(60) Provisional application No. 60/150,498, filed on Aug. 24, 1999.

(51) Int. Cl. G06K 9/36; G06K 9/00

(52) U.S. Cl. 382/232; 382/166

(57) ABSTRACT

The invention comprises a method of image compression, and more particularly, to an apparatus and method for compression of still images. In one embodiment, pixel data representing a color still image is separated into YIQ channels. A matrix is utilized to transform the pixel data from a space domain to a frequency domain for each of the channels. The transformed data is quantized and then encoded.

### RELATED APPLICATION

This application is a continuation application of U.S. application Ser. No. 09/645,211, filed Aug. 24, 2000, which claims priority to U.S. Provisional Application Serial No. 60/150,498, filed Aug. 24, 1999.

### FIELD OF THE INVENTION

This invention relates to image compression methodologies, and more particularly, to an apparatus and method for compression of still images.

### BACKGROUND OF THE INVENTION

Still image compression techniques have been improvised and improved significantly over the past ten years to envelop highly specialized algorithms and mathematical techniques in order to increase the compression ratio of the image. This has been especially the case in recent years as transmission of digital images, particularly color images, over computer networks or telephone lines is highly demanded by consumers. Particularly, transmission of these color images at high speed is desired. In order to increase the speed of transmission for the digitized color image, compression of the image is required. There has been traditionally a trade off between compression and quality however, requiring that the developer of compression techniques and apparatus choose between high compression ratios and therefor increased transmission speeds against the quality of the image once it is decompressed to its initial, or quasi-initial appearance. Inherent in most compression techniques are tradeoffs wherein, particular aspects of the image are sacrificed in order to compress the image to a satisfactory size. These losses of data can include loss of color definition, sharpness of edge lines, or other aspects of image quality. This sacrifice of image quality, particularly for color images, comes at a high cost, particularly when the typical compression ratio achieved is less than 20 to 1.

Standard image compression techniques include the following methodology:

In the Digital Conversion of Image step, an image is captured and stored in the computer by using a digital camera, or a video camera and video capture electronic card, or by scanning the image via a scanner and prepared in digital format which most likely includes representing the image in RGB, or YUV, or YIQ, or YCᵣC_{b}, or K₁K₂K₃ components. RGB, YUV, YIQ, YCᵣC_{b}, and K₁K₂K₃, formatting allows the color image to be broken down into distinct color spectra or luminance and two chrominance components, and then compressed based upon those spectra. After reducing the image to particular color or luminance-chrominance components, the components maybe broken down into blocks of pixels for easy manipulation and analysis. The next typical step involves generating the matrix transform wherein the image, in its component form, is transformed from one domain to another. This allows the image to be removed from the standard three dimensional image space to the frequency domain thereby causing the coefficients created to be the target of the compression routines and not the color component values themselves. The Discrete Cosine Transform or other frequency domain and create the coefficient matrix. These transforms indicate the behavior in the frequency domain of the image. The resulting transform coefficients are then compressed through quantization routines. Quantization may reduce the precision of the coefficients generated in the transform step but allows the actual values to be compressed. This quantization step scales the coefficients by a step size and then rounds off the value to the next integer. Finally, entropy or source encoding is utilized to further compress the quantized data. This encoding step may include run length encoding, Lempel-Ziv-Welch, Huffman, DPCM (differential pulse code modulation) or other well known coding techniques. More recently, DCT and various other frequency domain transformation matrices have been replaced with more complicated Wavelet transforms. As two types of compression models, lossy coding and lossless coding, have become standard, Wavelet transforms have provided a means to significantly increase compression ratios for the lossless type of compression model. In a lossless type of compression model, the input data, typically intensity data, is converted to codewords which have fewer storage requirements than the data that is coded. In the lossy model, intensity data may be quantized prior to utilization of codewords or transformation. Quantization eliminates those data elements which are not considered relevant to the characteristics of the image. Prior to the quantization step in lossy compression models, transforms are typically utilized to compress the data prior to action upon it by quantization routines. Wavelet transforms are based on a linear combination of waveforms that are not periodic but display a strong locality, i.e., the local specifics of the image. In wavelet transformations, unlike in a DCT transformation matrix, the image is transformed as a whole, not in modularized pixel blocks. A set of dependent functions are derived from a prototype function each of which have fundamental characteristics for transformation of the data (i.e. scale and transform) such that tradeoffs may be made based upon application specific requirements. These tradeoffs flow from resolution in the time and frequency domain. The dependent functions maybe scaled and transformed to meet the requirements of a particular application. Scaling and transformation coefficients are similar to the DCT coefficients. The varying dependent functions allow tradeoffs between the frequency and time resolution. Filtering of the image in the horizontal, vertical and diagonal direction may be accomplished to produce separate images through use of high and low filter pass techniques along with an average image signal. Iterative passes may be made to further compress the image thereby producing coefficients for each image which may then be compressed further through encoding or other methods mentioned above. These standard compression techniques cause significant degradation in the uncompressed image due to the varying manipulations to chrominance, luminance and loss of data during the compression routine. Thus, it is standard to see visually optimized transformation matrices or quantization steps which attempt to reduce the amount of data loss during the compression transformation.

### SUMMARY OF THE INVENTION

One object of the present invention is to provide a compression algorithm for color images which achieves large compression ratios and wherein the detection of error from the compression and decompression step is negligible.

Another object of the present invention is to provide a color image compression routine which provides coefficients for all frequency bands, except for the low frequency band, with expected value equal to zero.

A third object of the present invention is to provide methods of transformation which will not overburden a hardware system designed to compress and decompress the images thereby allowing high compression and decompression speeds through the use of efficient compression methodologies and standard electronics. Once object of this invention is to devise a DSP which provides lossless video color using a method of still image compression and motion detection, motion estimation, and motion compensation methods.

A fourth object of the present invention is to provide a high quality high compression ratio lossy still image compression to be used as part of our video compression method for fast transmission via a network and/or storing in a permanent storage device or the memory.

A fifth object of the present invention is for DSP to provide the means for fast still image compression and incorporation with our motion detection, where motion happens, what is the direction and the velocity, for security applications.

A sixth object of the present invention is for the DSP to include the still image compression with motion detection, to guide a camera to rotate and tilt in order to follow the motion.

A seventh object of the present invention is for the DSP to include the still image compression with the motion detection, motion direction, and velocity for military applications.

An eighth object of the present invention is to separate noise from motion.

A ninth object of the invention is transmission of the streamed video via the network with error checking, error detection, and error correction.

A tenth object of the invention is for movies on demand over the Internet.

An eleventh object of the invention is for news on demand and news archiving.

A twelfth object of the invention is for storing and archiving video of medical images for fast access, and small disk space requirements.

A thirteenth objects of the invention is for our compression chip incorporating our motion detection, motion compensation, and motion estimation method, for a DVD player.

A fourteenth object of the invention is a compression chip embodying the invention to be used for a DVD recorder.

A fifteenth object of the invention is a compression chip embodying the invention to be used for computer games.

A sixteenth object of the invention is a compression chip embodying the invention to be used for games of chance.

A seventeenth object of the invention is a compression chip embodying the invention to be used for video telephony communication via the computer and the Internet.

An eighteenth object of the invention is a compression chip embodying the invention to be used for video telephony communication via gateways and the Internet.

A nineteenth object of the invention is a compression chip embodying the invention to be used for video telephony communication via cellular phone.

A twentieth object of the invention is a compression chip embodying the invention to be used for telemedicine.

A twenty-first object of the invention is a compression chip embodying the invention to be used for nanomedicine and endoscopic surgery.

A twenty-second object of the invention is for instructions over the Internet.

Image compression algorithms created so far use the same transformation for the horizontal and vertical directions.

One aspect of the present invention is that the transformation used in this invention is stochastically orthogonal and not deterministically orthogonal.

Another aspect of the present invention is that the size of the filter transformation depends on the zone of influence of the auto-correlation function.

Another aspect of the present invention is that the present technique treats the horizontal and vertical directions differently depending on the aspect ratio and the anisotropic behavior of the auto-correlation function in the vertical and horizontal directions. Due to the fact that the aspect ratio of the horizontal and vertical pixels is usually not equal to one, and also due to the fact that the zone of influence of the auto-correlation function in the horizontal direction is not equal to the zone of influence of the auto-correlation function in the vertical direction, it is more efficient to use a different filter size in the horizontal direction than in the vertical direction. The higher the auto-correlation function between neighboring pixels and also the slower the auto-correlation function decreases as the space lag increases the larger the filter size is. The optimal filter size is computed mathematically so that conversion of the floating point data obtained by the transformation from the space domain to the frequency domain from floating points to integer numbers produces relatively small error. This error is bounded by a pre-defined value which represents the worse case analysis error and therefore produces pixels that are either identical to the corresponding pixels of the original image or they are very close to the pixels of the original image. The difference of the corresponding pixels of the original image and the restored image are bounded by the desired error boundary chosen so that the quality of the restored image is very high and therefore no visible differences exist between the original image and the restored image. The transformations are designed to divide the image signal into disjoint frequency bands. Each band has different amounts of energy. The sum of a small number of bands carries over 99.

Another aspect of the present invention is that the quantization step is directional and band dependent. The quantizer is designed so that it will not quantize the frequency bands where the energy of the system is relatively high. Alternatively, the frequency bands with relatively low energy are quantized inversely proportional to their variance. The error produced from this quantization as well as the error produced by the rounding off of the frequency domain is designed to produce a decompressed image with pixels having maximum distance/variance from the corresponding pixels of the original image which is less than a desired error boundary. Therefore when the image is compressed and subsequently decompressed, the error produced is too small for the eye to detect. Thus, a printout of the original image and the restored image looks identical to the eye.

### DETAILED DESCRIPTION OF THE INVENTION

The present invention comprises method and apparatus for compressing still image data. In one embodiment, the method includes the step of first separating a color image into the YIQ channels for compression. Of particular importance is the transformation matrix utilized in the conversion step from the space domain to the frequency domain. The filters utilized in the transformation step are dynamically altered to maximize efficiency based upon the actual data read. Further, the filters inspect both the horizontal and vertical directional channels differently dependent upon the particular behavior of that channel. Further, the quantization step is directional and band dependent so as to additionally increase the efficiency of the compression step based upon the data in the matrix. A brief outline of the compression steps is outlined below:

Design of the Transformation Matrix

The size of the transformation matrix is dynamic and depends on the zone of influence of the auto-correlation function. The transformation matrix used in the horizontal direction is not necessarily the same as the one used in the vertical direction. The two matrices could be different due to the presence of anisotropy in the image and the fact that the aspect ratio is not 1:1. The zone of influence of a pixel is defined as the minimum distance needed so that pixels with distance greater to this minimum distance are not correlated with the pixel. The dimension of the transformation matrix is selected to be such that the auto-correlation function between two pixels with distance equal to the dimension is greater than or equal to r, where r is less than 1 and greater than 0.5. If the horizontal transformation matrix is H then coefficients of the matrix H are computed so that the matrix H is stochastically orthonormal.

Under the assumption of wide sense stationarity the expected value of all bands except for the low band is equal to zero. The object is to find the parameters aᵢⱼ, ij=1, 2, 3, . . . N; j=1, 2, 3, . . . N, which maximizes the variance of the low band, minimizes the variance of all other bands, and satisfies the above constraints. A similar approach is used for the vertical transformation. This approach is used for each one of the color channels.

Quantization

The quantization matrix is designed to give one of two options. The first option is that the mean quare error between the original and the restored image which was quantized during the compression is less than an upper value. The second option is that the maximum error between the corresponding pixels of the restored and the original image is less than an upper value. In either case bands with variance larger than a function of the cutoff point are not subject to quantization, while the quantization of the bands with low energy is a function of the cutoff point and is inversely proportional to the variance of the band. Bands which are not quantized are subject to estimation using DPCM (differential pulse code modulation) with parameters proportional to their auto-correlation function.

Encoding

Another aspect of the invention related to the run-length used. The current process divides each band into squares of variable length. In every square the strength of numbers is reduced by subtracting the minimum from all the numbers in the square. Thus, several numbers are zero and the ones that are not zero are relatively small. In each square there is used a run-length that records the run-length of zero's, one's and two's, using rows, column, zigzag or cross designs. Squares which are all zeros are signified with a special symbol. Finally, Huffman coding or arithmetic coding is used to encode the data.

Decompression

The process of decompression is a reverse process, whereby the system decodes the image data, uses the inverse run-length process, uses the reverse differential pulse-code modulation (DPCM) estimation method for the bands that DPCM are applied, unquantizes the bands that were quantized and uses all the bands to restore the channel data for each channel using inverse matrix transformations. Finally, the channels are reorganized so that the pixels of the original image are restored.

Hardware

A computer board, consisting of the electronic connections (router), a Digital Signal Processing (DSP) chip with several adders and multipliers in the chip for a parallel processing of the image, with a super-pipeline is part of the hardware, software solution of the present invention. On the board there are several megabytes of fast access memory holding the image while it is being processed. A special PLD chip facilitates the communication of the board with the rest of the computer and its peripherals. The purpose of the board is to provide real time compression and/or decompression of relatively large images. All the compression and decompression software resides in the DSP. Furthermore, the DSP is designed so that it will run the software in a desired speed and time frame. The design of the DSP therefore is optimal only for the compression and decompression of the present methods.

I claim:

1. A method of compressing data representing a color still image comprising:
separating pixel data representing said color still image into YIQ channels;
utilizing a transformation matrix to convert said pixel data from a space domain to a frequency domain for each of said channels;
quantizing said transformed data; and
encoding said quantized data.
